(19) United States
(12) Patent Application Publication
(10) Pub. No.: US 2022/0001862 A1
(43) Pub. Date: Jan. 6, 2022

(54) OBSTACLE AVOIDANCE CONTROL DEVICE, VEHICLE, OBSTACLE AVOIDANCE CONTROL METHOD, AND NON-TRANSITORY COMPUTER-READABLE RECORDING MEDIUM STORING OBSTACLE AVOIDANCE CONTROL PROGRAM

(71) Applicant: Panasonic Intellectual Property Management Co., Ltd., Osaka (JP)

(72) Inventor: Shinichi ENDOU, Kanagawa (JP)

(73) Assignee: Panasonic Intellectual Property Management Co., Ltd., Osaka (JP)

(21) Appl. No.: 17/480,563

(22) Filed: Sep. 21, 2021

Related U.S. Application Data
(63) Continuation of application No. PCT/JP2020/007008, filed on Feb. 21, 2020.

(30) Foreign Application Priority Data
Mar. 25, 2019 (JP) 2019-056215

(51) Int. Cl. B60W 30/09

(52) U.S. Cl. CPC B60W 30/09; B60W 2552/00; B60W 2520/12; B60W 2520/10

(57) ABSTRACT

An obstacle avoidance control device is a device that, if an obstacle requiring avoidance is detected to the front in the travelling direction of a vehicle travelling on the basis of a preset set route, calculates an avoidance route for avoiding the obstacle and causes the vehicle to travel on the basis of the avoidance route. The obstacle avoidance control device includes: a detection unit that detects the direction in which an obstacle is present; and a control unit that, prior to calculation of the avoidance route, executes shift control for shifting the set route a prescribed distance in the travel direction of the vehicle and in a direction away from the direction in which the obstacle is present, and for causing the vehicle to travel on the basis of the shifted route.

### TECHNICAL FIELD

The present disclosure relates to an obstacle avoidance control apparatus, a vehicle, an obstacle avoidance control method, and a non-transitory computer-readable recording medium storing therein an obstacle avoidance control program.

### BACKGROUND ART

For example, Patent Literature (hereinafter, referred to as “PTL”) 1 discloses an obstacle avoidance control apparatus that calculates an avoidance route capable of avoiding an obstacle and controls traveling of a vehicle based on the avoidance route when the obstacle is detected on a forward side of a traveling direction of the vehicle traveling by automatic driving.

### CITATION LIST

### Patent Literature

PTL 1

Japanese Patent Application Laid-Open No. 2006-347236

### SUMMARY OF INVENTION

### Technical Problem

However, in conventional apparatuses, there is room for improvement in the riding comfort of an occupant when a vehicle avoids an obstacle.

An object of an aspect of the present disclosure is to provide an obstacle avoidance control apparatus, a vehicle, an obstacle avoidance control method, and a non-transitory computer-readable recording medium storing therein an obstacle avoidance control program that can improve the riding comfort of an occupant when a vehicle avoids an obstacle.

### Solution to Problem

An obstacle avoidance control apparatus according to an aspect of the present disclosure calculates an avoidance route for avoiding an obstacle and causes a vehicle to travel based on the avoidance route in a case where the obstacle requiring avoidance is detected on a forward side of a traveling direction of the vehicle traveling on a set route which is set in advance, the obstacle avoidance control apparatus including: a detector that detects a direction in which the obstacle is present; and a controller that executes, prior to calculating the avoidance route, a route-shifting control for shifting the set route by a predetermined distance in the traveling direction of the vehicle and a direction away from the direction in which the obstacle is present, and for causing the vehicle to travel based on the shifted route.

A vehicle according to an aspect of the present disclosure includes: a detector that detects a situation around a vehicle; a drive that executes acceleration, deceleration, and steering of the vehicle; and an obstacle avoidance control apparatus that calculates an avoidance route for avoiding an obstacle and controls the drive such that the vehicle travels based on the avoidance route in a case where the obstacle requiring avoidance is detected on a forward side of a traveling direction of the vehicle traveling on a set route which is set in advance, wherein the obstacle avoidance control apparatus includes: a detector that detects a direction in which the obstacle is present; and a controller that shifts, prior to calculating the avoidance route, the set route by a predetermined distance in the traveling direction of the vehicle and a direction away from the direction in which the obstacle is present, and controls the drive such that the vehicle travels based on the shifted route.

An obstacle avoidance control method according to an aspect of the present disclosure is performed by an apparatus that calculates an avoidance route for avoiding an obstacle and causes a vehicle to travel based on the avoidance route in a case where the obstacle requiring avoidance is detected on a forward side of a traveling direction of the vehicle traveling on a set route which is set in advance, the obstacle avoidance control method including: detecting a direction in which the obstacle is present; and executing, prior to calculating the avoidance route, a route-shifting control for shifting the set route by a predetermined distance in the traveling direction of the vehicle and a direction away from the direction in which the obstacle is present, and for causing the vehicle to travel based on the shifted route.

A non-transitory computer-readable recording medium storing therein an obstacle avoidance control program according to an aspect of the present disclosure is provided, the program causing a computer to calculate an avoidance route for avoiding an obstacle and to cause a vehicle to travel based on the avoidance route in a case where the obstacle requiring avoidance is detected on a forward side of a traveling direction of the vehicle traveling on a set route which is set in advance, the program causing a computer to perform processing including: detecting a direction in which the obstacle is present; and executing, prior to calculating the avoidance route, a route-shifting control for shifting the set route by a predetermined distance in the traveling direction of the vehicle and a direction away from the direction in which the obstacle is present, and for causing the vehicle to travel based on the shifted route.

### Advantageous Effects of Invention

According to the present disclosure, it is possible to improve the riding comfort of an occupant when a vehicle avoids an obstacle.

### BRIEF DESCRIPTION OF DRAWINGS

FIG. 1 is a schematic view of an exemplary positional relationship between a vehicle and an obstacle, which is provided for describing findings leading to the present disclosure;

FIG. 2 is a block diagram illustrating exemplary configurations of a vehicle and an obstacle avoidance control apparatus according to an embodiment of the present disclosure;

FIG. 3 illustrates an exemplary hardware configuration of a computer included in the obstacle avoidance control apparatus according to the embodiment of the present disclosure;

FIG. 4 is a flowchart illustrating an exemplary operation of the obstacle avoidance control apparatus according to the embodiment of the present disclosure;

FIG. 5 is a schematic diagram for describing an exemplary operation of a case where it is not possible to avoid an obstacle by a route-shifting control alone according to the embodiment of the present disclosure;

FIG. 6 is a schematic diagram for describing an exemplary operation of a case where it is possible to avoid an obstacle an obstacle by a route-shifting control alone according to the embodiment of the present disclosure; and

FIG. 7 is a schematic diagram for describing an exemplary operation of a case where continuation of the route-shifting control is unnecessary according to the embodiment of the present disclosure.

### DESCRIPTION OF EMBODIMENTS

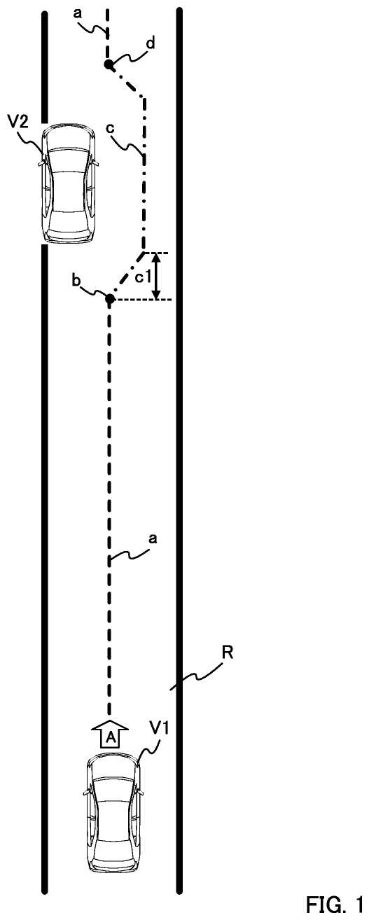

Findings leading to the present disclosure will be described with reference to FIG. 1. FIG. 1 is a schematic view of an exemplary positional relationship between vehicle V1 and vehicle V2 (an example of an obstacle). FIG. 1 illustrates vehicles V1 and V2 in a state as seen from directly above.

Vehicle V1 illustrated in FIG. 1 is a vehicle that performs automatic driving and is equipped with a conventional obstacle avoidance control apparatus. In this specification, the term “automatic driving” refers, for example, to an operation controlling traveling of a vehicle by controlling acceleration, deceleration, braking, and steering of the vehicle (i.e., by complete automatic driving) without requiring any driving operations performed by an occupant of the vehicle (e.g., acceleration, deceleration, braking, and steering).

In addition, although not illustrated in FIG. 1, vehicle V1 is equipped with a detection device that detects a situation around vehicle V1 (e.g., a radar device, an ultrasonic sonar, a camera).

Vehicle V1 illustrated in FIG. 1 is traveling on road R along set route “a” which is linear and is set in advance. Arrow A indicates a traveling direction of vehicle V1. Set route “a” is set, for example, in the center of a width direction of road R.

Vehicle V2 illustrated in FIG. 1 is stopped on the road shoulder on a left side of road R on a forward side of vehicle V1. Vehicle V2 is an example of an obstacle.

Here, when detecting vehicle V2 based on a detection result by the detection device, the conventional obstacle avoidance control apparatus calculates avoidance route “c”, avoidance traveling start position “b”, and avoidance traveling end position “d.”

As illustrated in FIG. 1, avoidance route “c” is a route that bypasses vehicle V2 rightward. Avoidance traveling start position “b” is a position where vehicle V1 starts traveling based on avoidance route “c” (hereinafter, referred to as “avoidance traveling”), and is set behind vehicle V2. Avoidance travel end position “d” is a position where vehicle V1 ends the avoidance traveling, and is set on a forward side of vehicle V2. Incidentally, set route “a” is set at a position ahead of avoidance traveling end position “d.” Hence, avoidance traveling end position “d” can be referred to as a position to return to set route “a.”

In order to calculate an avoidance route with high accuracy, it is necessary to collect as much as possible detection result information indicating detection results from the detection device and to analyze an obstacle (e.g., position, size, movement direction, and type of the obstacle, as well as relative speed between vehicle V1 and the obstacle) based on the information. Moreover, accuracy of the detection result information becomes higher as the vehicle approaches the obstacle. Thus, in order to improve the accuracy of the avoidance route, it is desirable that the vehicle approaches the obstacle as much as possible while taking a long time to collect information and analyze the obstacle.

However, when vehicle V1 approaches vehicle V2 while taking the long time described above, avoidance traveling start position “b” is set near vehicle V2. Moreover, avoidance route “c” thus calculated includes route “c1” on which steering to the right is performed.

As a result, a sharp turn is caused when vehicle V1 starts the avoidance traveling from avoidance travel start position “b” and travels based on route “c1,” and thus a problem arises in which the riding comfort of the occupant of vehicle V1 is deteriorated.

The present disclosure aims to improve the riding comfort of an occupant when a vehicle avoids an obstacle.

The findings leading to the present disclosure have been described above.

Hereinafter, an embodiment of the present disclosure will be described with reference to the accompanying drawings.

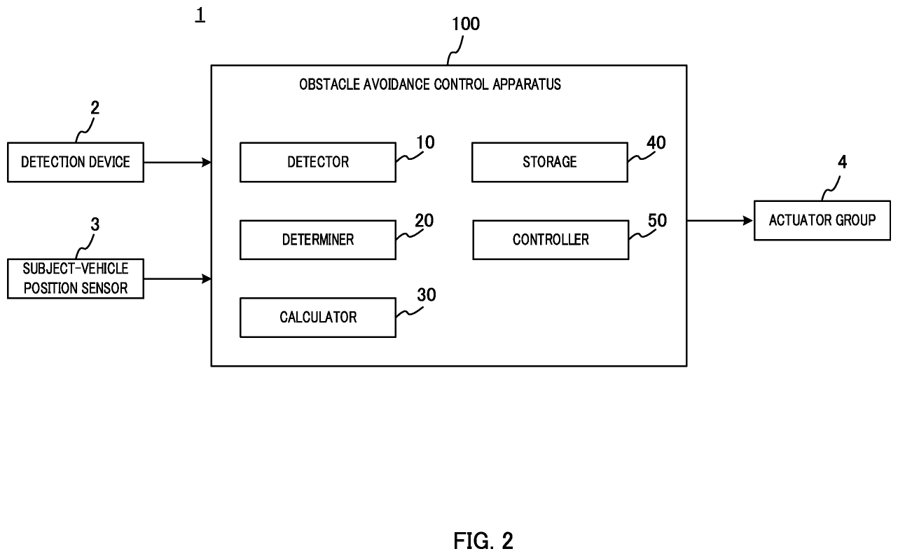

Configurations of vehicle 1 and obstacle avoidance control apparatus 100 according to the present embodiment will be described with reference to FIG. 2. FIG. 2 is a block diagram illustrating exemplary configurations of vehicle 1 and obstacle avoidance control apparatus 100 according to the present embodiment.

As illustrated in FIG. 2, vehicle 1 includes detection device 2 (an example of a detector), subject-vehicle position sensor 3, actuator group 4 (an example of a driver), and obstacle avoidance control apparatus 100. Vehicle 1 is, for example, an automobile that travels by automatic driving. Note that, in the following description, it is assumed that the term “traveling” refers to the traveling by automatic driving.

Obstacle avoidance control apparatus 100 is electrically connected to detection device 2, subject-vehicle position sensor 3, and actuator group 4.

Detection device 2 detects a situation of the periphery of vehicle 1 (front, rear, right, and left) and outputs detection result information indicating a detection result to obstacle avoidance control apparatus 100.

Examples of detection device 2 include, for example, a radar device that transmits radio waves on a forward side of vehicle 1 and receives the reflected waves, or an ultrasound sonar that transmits sound waves on the forward side of vehicle 1 and receives the reflected waves. As the radar device, a millimeter wave radar, or a laser radar may be used, for example. The laser radar is also referred to as Light Detection and Ranging (LIDAR). In one example, in a case where detection device 2 is the radar device or the ultrasound sonar, a received signal of the reflected wave is output to obstacle avoidance control apparatus 100 as the detection result information. Moreover, detection device 2 may be a camera (e.g., monocular camera or compound-eye camera) that captures an image in a forward direction of a vehicle. In this case, a captured image is output to obstacle avoidance control device 100 as the detection result information.

In the present embodiment, vehicle 1 may include detection device 2 that performs detection at least in the forward direction vehicle 1. Alternatively, for example, the radar device, the ultrasound sonar, and the camera, which are described above, may be used in combination.

Subject-vehicle position sensor 3 detects a position and orientation of vehicle 1 based on, for example, a signal received from Global Navigation Satellite System (GNSS) and outputs subject-vehicle position information indicating the detected position and orientation of vehicle 1 to obstacle avoidance control apparatus 100.

Note that, in the present embodiment, a description will be given with an example in which the position and orientation of vehicle 1 are detected by using subject-vehicle position sensor 3, the position and orientation of vehicle 1 may be detected by using a publicly known measure and method other than subject-vehicle position sensor 3.

Furthermore, although FIG. 2 illustrates only subject-vehicle position sensor 3, vehicle 1 is equipped with, for example, various sensors such as an accelerator position sensor that detects a position of an accelerator pedal, a shift position sensor that detects a position of a shift lever, a steering angle sensor that detects a steering angle, and a wheel speed sensor that detects the rotational speed of each wheel of vehicle 1. Each of these sensors is electrically connected to obstacle avoidance control apparatus 100 and outputs a signal indicating a detection result to obstacle avoidance control apparatus 100. The results of these detections, for example, are used in control of the traveling of vehicle 1.

Actuator group 4 is an actuator group that executes acceleration, deceleration, braking, steering, and the like of vehicle 1. Actuator group 4 includes, for example, various actuators such as a motor actuator that executes acceleration and deceleration, a brake actuator that executes braking, and a steering actuator that executes steering.

Obstacle avoidance control apparatus 100 is an apparatus that calculates an avoidance route for avoiding an obstacle and causes vehicle 1 to travel based on the avoidance route when an obstacle requiring avoidance is detected on a forward side of the traveling direction of vehicle 1 traveling on the set route which is set in advance.

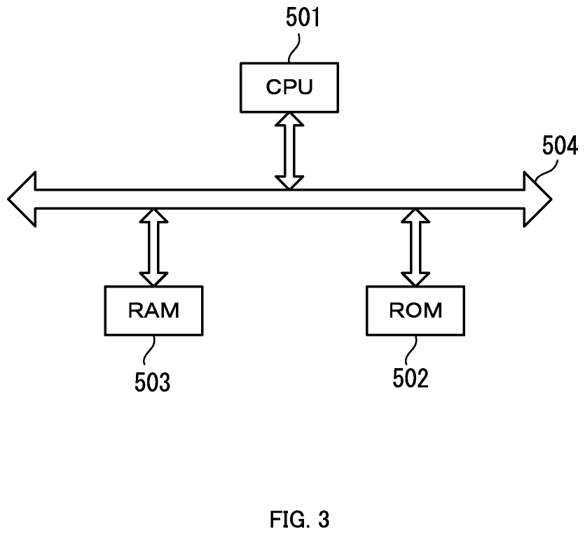

As illustrated in FIG. 3, obstacle avoidance control apparatus 100 includes as hardware, for example, Central Processing Unit (CPU) 501, Read Only Memory (ROM) 502 storing a computer program, and Random Access Memory (RAM) 503. CPU 501, ROM 502, and RAM 503 are connected to each other via bus 504.

Each function of obstacle avoidance control apparatus 100 described below is realized by executing the computer program read by CPU 501 from ROM 502. Moreover, the computer program may be stored in a predetermined recording medium and provided to a user or the like.

Obstacle avoidance control apparatus 100 includes detector 10, determiner 20, calculator 30, storage 40, and controller 50.

Detector 10 detects an obstacle present on a forward side of the traveling direction of vehicle 1 (hereinafter, referred to as a “front obstacle”) based on the detection result information received from detection device 2. At this time, detector 10 detects at least a direction in which the front obstacle is present (hereinafter, referred to as an “obstacle presence direction”).

The front obstacle is an object or living body partly or entirely lies on the course of vehicle 1. In addition, the front obstacle may be either in a moving or static state. Moreover, examples of the types of front obstacle include another vehicle (including an automobile, motorcycle, and the like), a human, a sign board for construction, a cone, and a fallen tree, but are not limited to these.

Besides, the obstacle presence direction is a right or left direction with reference to the traveling direction of vehicle 1. For example, in a case where the front obstacle is present on the right side with respect to the traveling direction of vehicle 1, the obstacle presence direction is the right direction. On the other hand, for example, when the front obstacle is present on the left side with respect to the traveling direction of vehicle 1, the obstacle presence direction is the left direction.

Moreover, after detecting the obstacle presence direction, detector 10 further performs analysis of the front obstacle based on the detection result information received from detection device 2. Specifically, detector 10 analyzes, for example, the position, size, movement direction, and type of the front obstacle, as well as the relative speed between vehicle 1 and the front obstacle. In the analysis of the relative speed, detector 10 may calculate the speed of vehicle 1 based on the detection result by a wheel speed sensor (not illustrated) or may calculate the speed of vehicle 1 by using another publicly known method.

In the following, information indicating an analysis result of the front obstacle is referred to as “analysis result information.” Furthermore, information indicating the speed of vehicle 1 calculated by detector 10 is referred to as “vehicle-speed information”.

For each process by detector 10 described above, a publicly known process can be used; thus, a detailed description thereof will be omitted.

In addition, each process by detector 10 is performed repeatedly during traveling of vehicle 1.

Determiner 20 makes the following various determinations.

Determiner 20 determines whether detector 10 has detected a front obstacle.

Moreover, determiner 20 determines whether detector 10 has completed an analysis of the front obstacle (completion of analysis). The term completion of analysis means, for example, that detector 10 recognizes all of the position, size, movement direction, and type of the front obstacle, as well as the relative speed between vehicle 1 and the front obstacle.

Furthermore, determiner 20 determines, based on the analysis result information, whether calculation of an avoidance route is necessary. The avoidance route is a bypass route for avoiding the front obstacle and is calculated by calculator 30 to be described later.

For example, determiner 20 determines that the calculation of the avoidance route is necessary when the front obstacle is present at a position to be in contact with vehicle 1 that continues to travel based on the set route. Furthermore, for example, determiner 20 determines that the calculation of the avoidance route is necessary when the front obstacle is moving toward the course of vehicle 1. Note that, conditions with which the calculation of the avoidance route is determined to be necessary are not limited to the condition described above.

Besides, determiner 20 determines whether calculator 30 has completed the calculation of the avoidance route.

Moreover, determiner 20 determines whether vehicle 1 has reached an avoidance traveling start position based on the subject-vehicle position information. The avoidance traveling start position (an example of the first position) is a position where vehicle 1 starts avoidance traveling (traveling based on the avoidance route) and is calculated by calculator 30 to be described later.

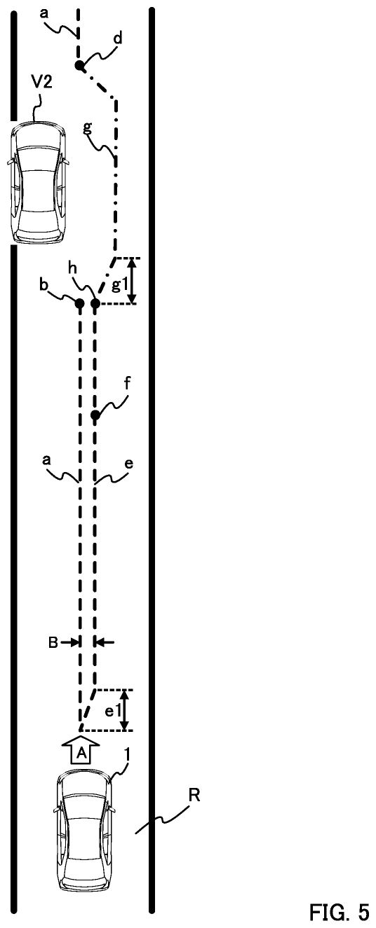

Furthermore, determiner 20 determines whether vehicle 1 has reached a deceleration traveling start position based on the subject-vehicle position information. The deceleration traveling start position (an example of the second position) is a position where vehicle 1 starts deceleration traveling and is calculated by calculator 30 to be described later. Note that, the deceleration traveling start position is a position before the avoidance traveling start position (on the vehicle 1 side) (see FIG. 5).

In the present embodiment, for convenience of explanation, a description has been given with an example in which obstacle avoidance control apparatus 100 includes determiner 20 as illustrated in FIG. 2, but obstacle avoidance control apparatus 100 may not include determiner 20. In this case, each process of determiner 20 described above may be performed by detector 10, calculator 30, or controller 50.

Calculator 30 calculates the avoidance route, the avoidance traveling start position, and the avoidance traveling end position based on the analysis result information, the subject-vehicle position information, and the vehicle-speed information. The avoidance traveling end position is a position where vehicle 1 ends the avoidance traveling (i.e., a position where vehicle 1 returns to the traveling based on the set route).

Furthermore, calculator 30 calculates the deceleration traveling start position based on the analysis result information, the subject-vehicle position information, and the vehicle-speed information.

For each process by calculator 30 described above, a publicly known process can be used; thus, a detailed description thereof will be omitted.

Storage 40 stores, for example, set route information indicating the set route, the analysis result information, the subject-vehicle position information, and the vehicle-speed information.

In the present embodiment, for convenience of explanation, a description has been given with an example in which obstacle avoidance control apparatus 100 includes storage 40 as illustrated in FIG. 2, but storage 40 may be provided outside obstacle avoidance control apparatus 100.

Controller 50 controls actuator group 4 such that vehicle 1 travels based on the set route. This control causes vehicle 1 to travel based on the set route.

In addition, controller 50 executes a route-shifting control before the avoidance route is calculated (e.g., at a timing the front obstacle is detected by detector 10).

The route-shifting control is a control for shifting the set route by a predetermined distance in the traveling direction of vehicle 1 and a direction away from the obstacle presence direction, and for causing vehicle 1 to travel based on the shifted route. For example, at the timing the obstacle presence direction is detected to be the left direction by detector 10, controller 50 shifts the set route by the predetermined distance to the right and controls actuator group 4 such that vehicle 1 travels based on the route (hereinafter, referred to as a “shifted route”). The predetermined distance is, for example, but not limited to, a length approximately twice the width (e.g., around 30 cm) of a line attached to a road (e.g., a white line).

Moreover, controller 50 executes a deceleration control when vehicle 1 traveling on the shifted route reaches the deceleration traveling start position.

The deceleration control is a control for decelerating vehicle 1. For example, controller 50 controls actuator group 4 such that vehicle 1 travels at low speed (e.g., 10 km/h or less). Note that, the vehicle speed after the deceleration is not limited to the low speed.

Furthermore, controller 50 executes the avoidance traveling control when vehicle 1 traveling on the shifted route reaches the avoidance traveling start position which is set at a position ahead (on the obstacle side) of the deceleration traveling start position.

The avoidance traveling control is a control for causing vehicle 1 to execute the avoidance traveling. For example, controller 50 controls actuator group 4 such that vehicle 1 travels based on the avoidance route during a distance from the avoidance traveling start position to the avoidance traveling end position.

The configurations of vehicle 1 and obstacle avoidance control apparatus 100 have been described above.

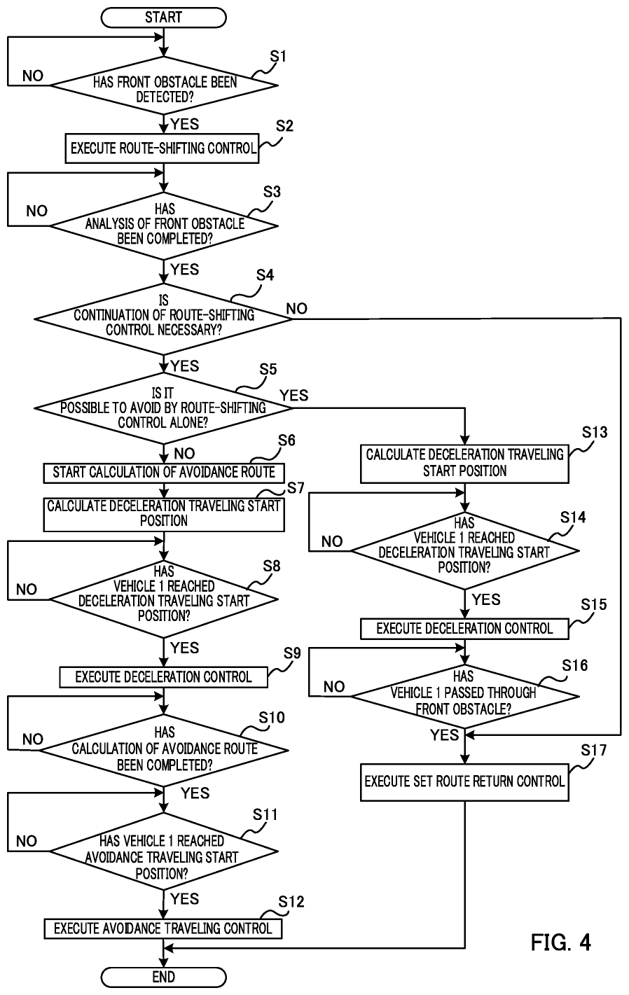

Next, an operation of obstacle avoidance control apparatus 100 will be described with reference to FIGS. 4 to 7. FIG. 4 is a flowchart illustrating an exemplary operation of obstacle avoidance control apparatus 100. FIGS. 5 to 7 are schematic views for describing the respective operation examples. FIGS. 5 to 7 illustrate vehicles 1 and V2 (an example of a front obstacle) in a state as seen from directly above. In FIGS. 5 to 7, an element the same as in FIG. 1 is given the same reference numeral.

In the following, as illustrated in FIGS. 5 to 7, a description will be given with an example in which a flow illustrated in FIG. 4 starts when vehicle 1 is traveling on road R along set route “a” while vehicle V2 is stopped on the road shoulder on the left side of road R on a forward side of the traveling direction of vehicle 1.

First, determiner 20 determines whether detector 10 has detected a front obstacle (step S1).

In a case where detector 10 has not detected a front obstacle (step S1: NO), the flow returns to step S1.

Here, as an example, it is assumed that detector 10 detects vehicle V2 as a front obstacle when vehicle 1 is in positions illustrated in FIGS. 5 to 7 (step S1: YES). At this time, detector 10 detects that an obstacle presence direction of vehicle V2 is the left direction. Detector 10 then continues to collect detection result information from detection device 2 and starts analysis of vehicle V2 based on the detection result information.

Next, controller 50 executes the route-shifting control (step S2).

As described above, the route-shifting control is performed at, for example, the timing vehicle V2 is detected (or the timing the obstacle presence direction of vehicle V2 is detected). First, controller 50 shifts set route “a” by predetermined distance B in the right direction which is a direction opposite to the left direction detected as the obstacle presence direction. Thus, shifted route “e” is set. Controller 50 then controls actuator group 4 such that vehicle 1 travels based on shifted route “e.” Vehicle 1 starts traveling based on shifted route “e,” accordingly. Shifted route “e” includes route “e1” on which steering to the right is performed.

Next, when vehicle 1 is traveling based on shifted route “e,” determiner 20 determines whether detector 10 has completed the analysis of vehicle V2 which is the front obstacle (step S3).

In a case where detector 10 has not completed the analysis of vehicle V2 (step S3: NO), the flow returns to step S3. In this case, vehicle 1 continues to travel on shifted route “e.”

On the other hand, when detector 10 has completed the analysis of vehicle V2 (step S3: YES), determiner 20 determines whether continuation of the route-shifting control is necessary based on the analysis result information (step S4).

In a case where the continuation of the route-shifting control is not necessary (step S4: NO), controller 50 executes a set route return control for causing vehicle 1, which is traveling based on shifted route “e,” to return to the traveling based on set route “a” (step S17).

An example of the case where the continuation of the route-shifting control is not necessary includes, for example, a case in which vehicle V2 can be avoided even when vehicle 1 returns to the traveling based on set route “a.”

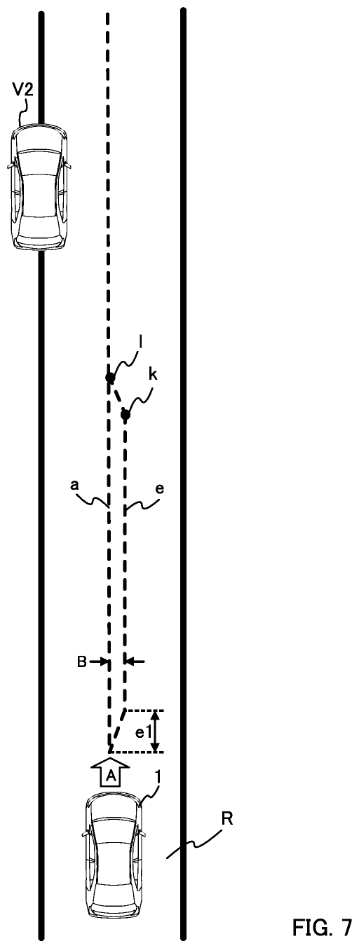

For example, it is assumed that the continuation of the route-shifting control is determined unnecessary before vehicle 1 traveling based on shifted route “e” reaches position “k” illustrated in FIG. 7. In this case, controller 50 controls actuator group 4 such that vehicle 1 performs steering to the left at a timing vehicle 1 reaches position “k” and, from position “l,” starts traveling based on the set route “a.” As a result, vehicle 1 traveling on shifted route “e” performs a turn to the left at position “k,” performs traveling based on set route “a” from position “l,” and passes through the right side of vehicle V2. In this case, vehicle 1 performs the series of traveling described above without decelerating. Incidentally, positions “k” and “l” illustrated in FIG. 7, are merely examples and not limited to as illustrated in FIG. 7.

In a case where the continuation of the route-shifting control is necessary (step S4: YES), determiner 20, based on the analysis result information, determines whether it is possible to avoid vehicle V2 by the route-shifting control alone (without performing the avoidance traveling) (step S5).

In a case where it is possible to avoid vehicle V2 by the route-shifting control alone (step S5: YES), the flow proceeds to step S13. On the other hand, in a case where it is not possible to avoid vehicle V2 by the route-shifting control alone (step S5: NO), the flow proceeds to step S6. Step S6 and subsequent steps will be described later. In the following, steps S13 to S17 will be described.

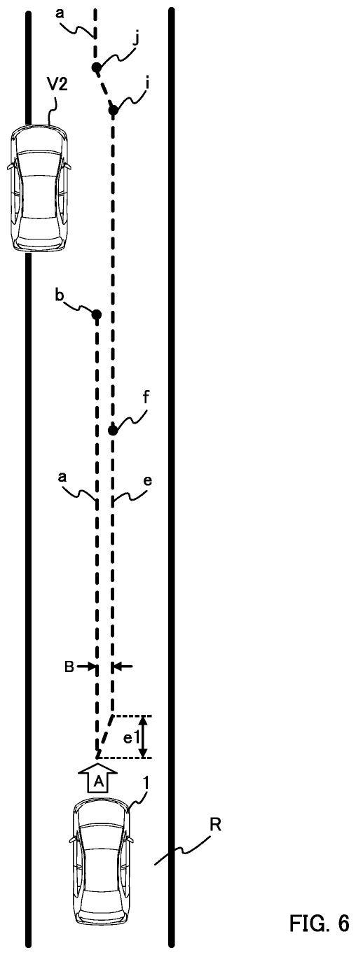

Next, calculator 30 calculates deceleration traveling start position “f” illustrated in FIG. 6 based on the analysis result information, the subject-vehicle position information, and the vehicle speed information (step S13).

As illustrated in FIG. 6, deceleration traveling start position “f” thus calculated is, for example, set on a rear side of vehicle V2 on shifted route “e.” Incidentally, deceleration traveling start position “f” illustrated in FIG. 6 is a merely example and not limited to as illustrated in FIG. 6.

Next, determiner 20, based on the subject-vehicle position information, determines whether vehicle 1 traveling based on shifted route “e” has reached deceleration traveling start position “f” (step S14).

In a case where vehicle 1 has not reached deceleration traveling start position “f” (step S14: NO), the flow returns to step S14.

In a case where vehicle 1 has reached deceleration traveling start position “f” (step S14: YES), controller 50 executes the deceleration control (step S15).

For example, controller 50 controls actuator group 4 such that vehicle 1 travels at low speed. As a result, for example, vehicle 1 starts traveling at the low speed from deceleration traveling start position “f” illustrated in FIG. 6. Thereafter, vehicle 1 continues to travel based on shifted route “e” at the low speed.

Next, determiner 20, based on the subject-vehicle position information and the analysis result information, determines whether vehicle 1 has passed through vehicle V2 which is the front obstacle (step S16).

In a case where vehicle 1 has not passed through vehicle V2 (step S16: NO), the flow returns to step S16.

In a case where vehicle 1 has passed through vehicle V2 (step S16: YES), controller 50 performs the set route return control (step S17).

For example, when vehicle 1 slowly traveling based on shifted route “e” passes through the right side of vehicle V2 and reaches position “i” illustrated in FIG. 6, controller 50 controls actuator group 4 such that vehicle 1 performs steering to the left and starts traveling based on set route “a” from position “j.” As a result, vehicle 1 traveling on shifted route “e” performs a turn to the left at position “i” and returns to the traveling based on set route “a” from position “j.” Besides, vehicle 1 that has returned to the traveling based on set route “a” travels at a speed before the deceleration control.

Steps S13 to S17 have been described above.

In a case where vehicle V2 cannot be avoided by the route-shifting control alone (step S5: NO), calculator 30 starts calculation of avoidance route “g” illustrated in FIG. 5 based on the analysis result information, the subject-vehicle position information, and the vehicle speed information (step S6).

As illustrated in FIG. 5, avoidance route “g” thus calculated includes route “g1” on which steering to the right is performed. Note that, the route further from route “g1” is the same as in the case of avoidance route “c” illustrated in FIG. 1.

In addition, in step S6, calculator 30 further calculates avoidance traveling start position “h” and avoidance traveling end position “d” illustrated in FIG. 5. As illustrated in FIG. 5, for example, avoidance traveling start position “h” is the same as a position obtained by shifting avoidance traveling start position “b” described with reference to FIG. 1 by predetermined distance B in the right direction.

Next, calculator 30 calculates deceleration traveling start position “f” illustrated in FIG. 5 based on the analysis result information, the subject-vehicle position information, and the vehicle speed information (step S7).

As illustrated in FIG. 5, deceleration traveling start position “f” thus calculated is, for example, set on a position before avoidance traveling start position “h” (on the vehicle 1 side) on shifted route “e.”

Note that, in FIG. 4, a case has been exemplified in which step S7 is performed after step S6, but step S6 may be performed after step S7

Next, determiner 20, based on the subject-vehicle position information, determines whether vehicle 1 traveling based on shifted route “e” has reached deceleration traveling start position “f” (step S8).

In a case where vehicle 1 has not reached deceleration traveling start position “f” (step S8: NO), the flow returns to step S8.

In a case where vehicle 1 has reached deceleration traveling start position “f” (step S8: YES), controller 50 executes the deceleration control (step S9).

For example, controller 50 controls actuator group 4 such that vehicle 1 travels at low speed. As a result, for example, vehicle 1 starts traveling at the low speed from deceleration traveling start position “f” illustrated in FIG. 5.

Next, determiner 20 determines whether calculator 30 has completed the calculation of avoidance route “g” (step S10).

In a case where calculator 30 has not completed the calculation of avoidance route “g” (step S10: NO), the flow returns to step S10. In this case, vehicle 1 continues to travel the shifted route “e” at the low speed.

In a case where calculator 30 has completed the calculation of avoidance route “g” (step S10: YES), determiner 20, based on the subject-vehicle position information, determines whether vehicle 1 has reached avoidance traveling start position “h” (step S11).

In a case where vehicle 1 has not reached avoidance traveling start position “h” (step S11: NO), the flow returns to step S11. In this case, vehicle 1 continues to travel the shifted route “e” at the low speed.

In a case where vehicle 1 has reached avoidance traveling start position “h” (step S11: YES), controller 50 executes the avoidance traveling control (step S12).

For example, controller 50 controls actuator group 4 such that vehicle 1 travels based on avoidance route “g” during a distance from avoidance traveling start position “h” to avoidance traveling end position “d.” Vehicle 1 travels based on avoidance route “g,” accordingly.

As described above, since avoidance traveling start position “h” is shifted by predetermined distance B to the right direction from avoidance traveling start position “b,” a steering angle on route “g1” is smaller than a steering angle on route “c1” illustrated in FIG. 1. Thus, when vehicle 1 travels on route “g1,” a turn will be gentle compared with the case where vehicle 1 travels on route “c1.” Consequently, it is possible to improve the riding comfort of the occupant when vehicle 1 avoids the obstacle.

Thereafter, when determiner 20 determines that vehicle 1 has reached avoidance traveling end position “d,” controller 50 controls actuator group 4 such that vehicle 1 travels based on set route “a.” Thus, vehicle 1 again starts traveling based on set route “a.”

The operation of obstacle avoidance control apparatus 100 has been described above.

As described in detail above, in the present embodiment, when a front obstacle is detected while a vehicle is traveling based on a set route, the set route is shifted by a predetermined distance in a traveling direction of the vehicle and a direction away from a presence direction of the front obstacle prior to calculating of an avoidance route, and the vehicle travels based on the shifted route, accordingly. That is, by making a slight turn before the vehicle starts traveling based on the avoidance route, it is possible to achieve a gentle turn when vehicle 1 travels based on the avoidance route. Thus, it is possible to improve the riding comfort of an occupant when a vehicle avoids an obstacle.

Note that, the embodiment described above can be variously modified without departing from the spirit thereof. Hereinafter, variations will be described.

[Variation 1]

In the embodiment, a description has been given with an example in which the route-shifting control is executed at the timing the front obstacle is detected by detector 10, but the present disclosure is not limited to this.

Controller 50 may change the timing of executing the route-shifting control based on the speed of vehicle 1 at the time of detection of the front obstacle.

For example, in a case where the speed of vehicle 1 at the time of detection of the front obstacle is equal to or greater than a threshold value which is set preliminarily, controller 50 may execute the route-shifting control immediately after the detection of the front obstacle. In addition, for example, in a case where the speed of vehicle 1 at the time of detection of the front obstacle is less than the preliminary set threshold value, controller 50 may execute the route-shifting control after a predetermined time elapses (e.g., a few seconds) from the detection of the front obstacle.

In the above description, a description has been given with an example in which the speed of vehicle 1 is used. However, in a situation where it is possible to detect a relative speed between vehicle 1 and the front obstacle when the front obstacle is detected, the relative speed may be used.

[Variation 2]

Controller 50 may execute the route-shifting control more than once until vehicle 1 reaches the deceleration traveling start position.

For example, in FIG. 5, until vehicle 1 traveling on shifted route “e” reaches deceleration traveling start position “f,” controller 50 may set a shifted route obtained by shifting shifted route “e” further by predetermined distance B to the right direction, and cause vehicle 1 to travel based on the shifted route.

[Variation 3]

Controller 50 may determine a predetermined distance based on a width of road R on which vehicle 1 is traveling.

[Variation 4]

Controller 50 may be configured not to execute the route-shifting control in a case where the speed of vehicle 1 at the time of detection of the front obstacle is equal to or less than a threshold value which is set in advance (e.g., 10 km/h).

[Variation 5]

In the embodiment, a description has been given with an example in which obstacle avoidance control apparatus 100 includes detector 10 as illustrated in FIG. 2, but detector 10 may be provided outside obstacle avoidance control apparatus 100.

The variations have been described above. Incidentally, the respective variations may be realized in combination as appropriate.

SUMMARY OF THE PRESENT DISCLOSURE

The summary of the present disclosure is as follows.

An obstacle avoidance control apparatus of the present disclosure calculates an avoidance route for avoiding an obstacle and causes a vehicle to travel based on the avoidance route in a case where the obstacle requiring avoidance is detected on a forward side of a traveling direction of the vehicle traveling on a set route which is set in advance, the obstacle avoidance control apparatus including: a detector that detects a direction in which the obstacle is present; and a controller that executes, prior to calculating the avoidance route, a route-shifting control for shifting the set route by a predetermined distance in the traveling direction of the vehicle and a direction away from the direction in which the obstacle is present, and for causing the vehicle to travel based on the shifted route.

In the obstacle avoidance control apparatus of the present disclosure, the calculating of the avoidance route is performed in a case where the obstacle is determined as the obstacle requiring avoidance based on an analysis result of the obstacle while the vehicle is traveling based on the shifted route.

In the obstacle avoidance control apparatus of the present disclosure, the controller decelerates the vehicle in a case where the vehicle reaches a second position which is set at a position before a first position where the vehicle starts traveling based on the avoidance route.

In the obstacle avoidance control apparatus of the present disclosure, the controller executes the route-shifting control more than once until the vehicle reaches the second position.

In the obstacle avoidance control apparatus of the present disclosure, the controller executes the route-shifting control at a timing the obstacle is detected.

In the obstacle avoidance control apparatus of the present disclosure, the controller changes a timing of executing the route-shifting control based on a speed of the vehicle at the time of detection of the obstacle.

In the obstacle avoidance control apparatus of the present disclosure, the controller determines the predetermined distance based on a width of a road on which the vehicle is traveling.

In the obstacle avoidance control apparatus of the present disclosure, the controller does not execute the route-shifting control in a case where the speed of the vehicle at the time of detection of the obstacle is equal to or less than a threshold value.

A vehicle of the present disclosure includes: a detector that detects a situation around a vehicle; a drive that executes acceleration, deceleration, and steering of the vehicle; and an obstacle avoidance control apparatus that calculates an avoidance route for avoiding an obstacle and controls the drive such that the vehicle travels based on the avoidance route in a case where the obstacle requiring avoidance is detected on a forward side of a traveling direction of the vehicle traveling on a set route which is set in advance, wherein the obstacle avoidance control apparatus includes: a detector that detects a direction in which the obstacle is present; and a controller that shifts, prior to calculating the avoidance route, the set route by a predetermined distance in the traveling direction of the vehicle and a direction away from the direction in which the obstacle is present, and controls the drive such that the vehicle travels based on the shifted route.

An obstacle avoidance control method of the present disclosure is performed by an apparatus that calculates an avoidance route for avoiding an obstacle and causes a vehicle to travel based on the avoidance route in a case where the obstacle requiring avoidance is detected on a forward side of a traveling direction of the vehicle traveling on a set route which is set in advance, the obstacle avoidance control method including: detecting a direction in which the obstacle is present; and executing, prior to calculating the avoidance route, a route-shifting control for shifting the set route by a predetermined distance in the traveling direction of the vehicle and a direction away from the direction in which the obstacle is present, and for causing the vehicle to travel based on the shifted route.

A non-transitory computer-readable recording medium storing therein an obstacle avoidance control program of the present disclosure is provided, the program causing a computer to calculate an avoidance route for avoiding an obstacle and to cause a vehicle to travel based on the avoidance route in a case where the obstacle requiring avoidance is detected on a forward side of a traveling direction of the vehicle traveling on a set route which is set in advance, the program causing a computer to perform processing including: detecting a direction in which the obstacle is present; and executing, prior to calculating the avoidance route, a route-shifting control for shifting the set route by a predetermined distance in the traveling direction of the vehicle and a direction away from the direction in which the obstacle is present, and for causing the vehicle to travel based on the shifted route.

The disclosure of Japanese Patent Application No. 2019-056215, filed on Mar. 25, 2019, including the specification, drawings and abstract, is incorporated herein by reference in its entirety.

### INDUSTRIAL APPLICABILITY

The obstacle avoidance control apparatus, the vehicle, the obstacle avoidance control method, and the non-transitory computer-readable recording medium storing therein an obstacle avoidance control program of the present disclosure are useful when causing traveling vehicles to avoid obstacles.

### REFERENCE SIGNS LIST

1 Vehicle

2 Detection device

3 Subject-vehicle position sensor

4 Actuator group

10 Detector

20 Determiner

30 Calculator

40 Storage

50 Controller

100 Obstacle avoidance control apparatus

1. An obstacle avoidance control apparatus that calculates an avoidance route for avoiding an obstacle and causes a vehicle to travel based on the avoidance route in a case where the obstacle requiring avoidance is detected on a forward side of a traveling direction of the vehicle traveling on a set route which is set in advance, the obstacle avoidance control apparatus comprising:
a detector that detects a direction in which the obstacle is present; and
a controller that executes, prior to calculating the avoidance route, a route-shifting control for shifting the set route by a predetermined distance in the traveling direction of the vehicle and a direction away from the direction in which the obstacle is present, and for causing the vehicle to travel based on the shifted route.

2. The obstacle avoidance control apparatus according to claim 1, wherein
the calculating of the avoidance route is performed in a case where the obstacle is determined as the obstacle requiring avoidance based on an analysis result of the obstacle while the vehicle is traveling based on the shifted route.

3. The obstacle avoidance control apparatus according to claim 1, wherein
the controller decelerates the vehicle in a case where the vehicle reaches a second position which is set at a position before a first position where the vehicle starts traveling based on the avoidance route.

4. The obstacle avoidance control apparatus according to claim 3, wherein
the controller executes the route-shifting control more than once until the vehicle reaches the second position.

5. The obstacle avoidance control apparatus according to claim 1, wherein
the controller executes the route-shifting control at a timing the obstacle is detected.

6. The obstacle avoidance control apparatus according to claim 1, wherein
the controller changes a timing of executing the route-shifting control based on a speed of the vehicle at the time of detection of the obstacle.

7. The obstacle avoidance control apparatus according to claim 1, wherein
the controller determines the predetermined distance based on a width of a road on which the vehicle is traveling.

8. The obstacle avoidance control apparatus according to claim 1, wherein
the controller does not execute the route-shifting control in a case where the speed of the vehicle at the time of detection of the obstacle is equal to or less than a threshold value.

9. A vehicle, comprising:
a detector that detects a situation around a vehicle;
a drive that executes acceleration, deceleration, and steering of the vehicle; and
an obstacle avoidance control apparatus that calculates an avoidance route for avoiding an obstacle and controls the drive such that the vehicle travels based on the avoidance route in a case where the obstacle requiring avoidance is detected on a forward side of a traveling direction of the vehicle traveling on a set route which is set in advance, wherein
the obstacle avoidance control apparatus includes:
a detector that detects a direction in which the obstacle is present; and
a controller that shifts, prior to calculating the avoidance route, the set route by a predetermined distance in the traveling direction of the vehicle and a direction away from the direction in which the obstacle is present, and controls the drive such that the vehicle travels based on the shifted route.

10. An obstacle avoidance control method performed by an apparatus that calculates an avoidance route for avoiding an obstacle and causes a vehicle to travel based on the avoidance route in a case where the obstacle requiring avoidance is detected on a forward side of a traveling direction of the vehicle traveling on a set route which is set in advance, the obstacle avoidance control method comprising:
detecting a direction in which the obstacle is present; and
executing, prior to calculating the avoidance route, a route-shifting control for shifting the set route by a predetermined distance in the traveling direction of the vehicle and a direction away from the direction in which the obstacle is present, and for causing the vehicle to travel based on the shifted route.

11. A non-transitory computer-readable recording medium storing therein an obstacle avoidance control program causing a computer to calculate an avoidance route for avoiding an obstacle and to cause a vehicle to travel based on the avoidance route in a case where the obstacle requiring avoidance is detected on a forward side of a traveling direction of the vehicle traveling on a set route which is set in advance, the program causing a computer to perform processing comprising:
detecting a direction in which the obstacle is present; and
executing, prior to calculating the avoidance route, a route-shifting control for shifting the set route by a predetermined distance in the traveling direction of the vehicle and a direction away from the direction in which the obstacle is present, and for causing the vehicle to travel based on the shifted route.
